(19) United States
(12) Patent Application Publication
(10) Pub. No.: US 2013/0232449 A1
(43) Pub. Date: Sep. 5, 2013

(54) GRAPHICAL USER INTERFACE MECHANISMS

(71) Applicant: Karl Butler, Aukland (NZ)

(72) Inventor: Karl Butler, Aukland (NZ)

(73) Assignee: TRIGGER HAPPY, LTD., Aukland (NZ)

(21) Appl. No.: 13/786,159

(22) Filed: Mar. 5, 2013

Related U.S. Application Data
(60) Provisional application No. 61/606,812, filed on Mar. 5, 2012.

(51) Int. Cl. G06F 3/0481

(52) U.S. Cl. CPC G06F 3/04817
USPC 715/834

(57) ABSTRACT

A machine-controlled method can include a display of an electronic device visually presenting to a user a graphical user interface having a trigger mechanism component. The method can also include the display visually presenting to the user a rotational interface mechanism having multiple toolset icons responsive to the user interacting with the trigger mechanism component. The method can also include the display visually presenting to the user individual tool icons that correspond to a certain toolset icon.

### CROSS-REFERENCE TO RELATED APPLICATION

This application claims the benefit of U.S. Provisional Patent Application No. 61/606,812, titled “GRAPHICAL USER INTERFACE MECHANISMS” and filed on Mar. 5, 2012, which is hereby incorporated herein by reference in its entirety.

### TECHNICAL FIELD

The disclosed technology pertains generally to tools and techniques for presenting graphical user interfaces to users.

### BACKGROUND

Over the years, computing devices have evolved dramatically and, consequently, so have graphical user interface (GUI) mechanisms for use with such devices. While computing devices have becoming increasingly handheld, e.g., tablet-type devices, however, GUI mechanisms have not adapted accordingly. For example, many GUI mechanisms still require multiple-finger interactions or use of an extra device or component, e.g., stylus, in order to accomplish certain user-requested functions.

Thus, there remains a need for a way to address these and other problems associated with the prior art.

### BRIEF DESCRIPTION OF THE DRAWINGS

FIG. 1 illustrates a first example of an electronic device having a display, e.g., screen, that may be configured to present to a user a graphical user interface (GUI) in accordance with certain embodiments of the disclosed technology.

FIG. 2 illustrates a second example of an electronic device, such as the electronic device illustrated by FIG. 1, in accordance with certain embodiments of the disclosed technology.

FIG. 3 illustrates a third example of an electronic device, such as the electronic device illustrated by FIGS. 1 and 2, in accordance with certain embodiments of the disclosed technology.

FIG. 4 illustrates a fourth example of an electronic device, such as the electronic devices illustrated by FIGS. 1-3, in accordance with certain embodiments of the disclosed technology.

FIG. 5 illustrates a first position for a representation of a rotational interface mechanism implemented as a virtual bicycle chain in accordance with certain embodiments of the disclosed technology.

FIG. 6 illustrates a second position for a representation of a rotational interface mechanism implemented as a virtual bicycle chain in accordance with certain embodiments of the disclosed technology.

FIG. 7 illustrates a third position for a representation of a rotational interface mechanism implemented as a virtual bicycle chain in accordance with certain embodiments of the disclosed technology.

FIG. 8 illustrates a fourth position for a representation of a rotational interface mechanism implemented as a virtual bicycle chain in accordance with certain embodiments of the disclosed technology.

FIG. 9 illustrates an embodiment in which a rotational interface mechanism is implemented as a virtual loop in accordance with certain embodiments of the disclosed technology.

### DETAILED DESCRIPTION

Embodiments of the disclosed technology may be implemented in connection with certain applications, e.g., content creation applications, configured to be operated on a computing device such as an Apple® iPhone device, iPad device, or iPod Touch device, or any smartphone, tablet computing device, portable media device, or other type of personal computing device.

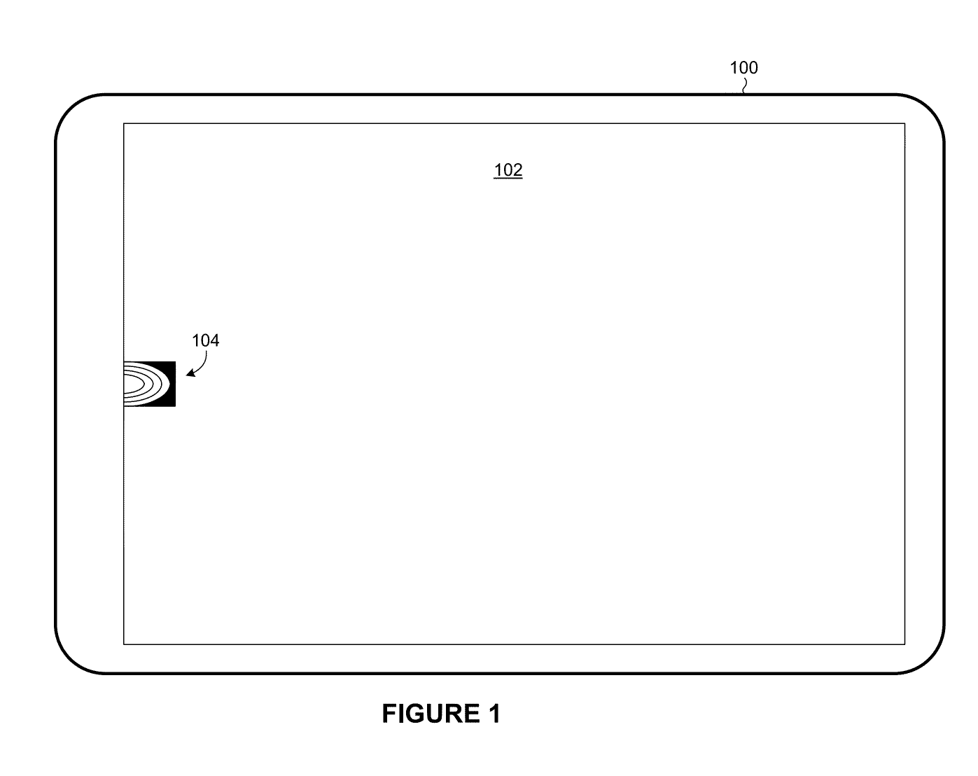

FIG. 1 illustrates a first example of an electronic device 100 having a display 102, e.g., touchscreen, that may be configured to present to a user a graphical user interface (GUI) in accordance with certain embodiments of the disclosed technology. In the example, the GUI includes a trigger mechanism component 104, e.g., icon, that may be specifically designed for interaction with, and control or direction by, a certain finger of the user. In certain embodiments, for example, the trigger mechanism component 104 may be designed to be interacted with, and controlled and/or directed by, the thumb of the user's supporting hand while the user is holding the electronic device 100.

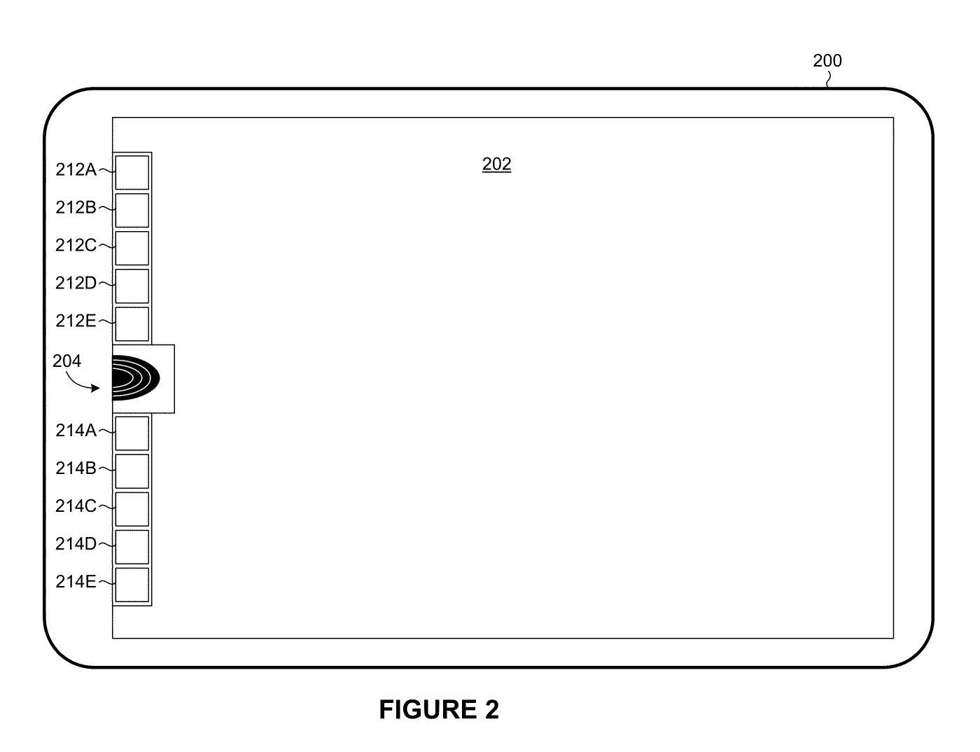

FIG. 2 illustrates a second example of an electronic device 200, such as the electronic device 100 illustrated by FIG. 1, in accordance with certain embodiments of the disclosed technology. In the example, the electronic device 200 has a display 202 configured to present to a user a GUI that includes a trigger mechanism component 204 and individual tool icons 212A-212E and 214A-214E, which may be displayed responsive to a user performing a tap function, e.g., quick tap or double-tap, or otherwise placing his or her finger, e.g., thumb, on the trigger mechanism component 204. In certain embodiments, the individual tool icons 212A-212E and 214A-214E will be displayed until the user performs a subsequent tap function on the trigger mechanism component 204. Each of the individual tool icons 212A-212E and 214A-214E may correspond to any of a number of settings, functions, modes, etc. A user may lock the individual tool icons 212A-212E and 214A-214E in place by swiping his or her finger from a first pre-designated area, e.g., on or near the trigger mechanism component 204, to a second pre-designated area, e.g., any other portion of the display 202 outside of the trigger mechanism component 204 and individual tool icons 212A-212E and 214A-214E.

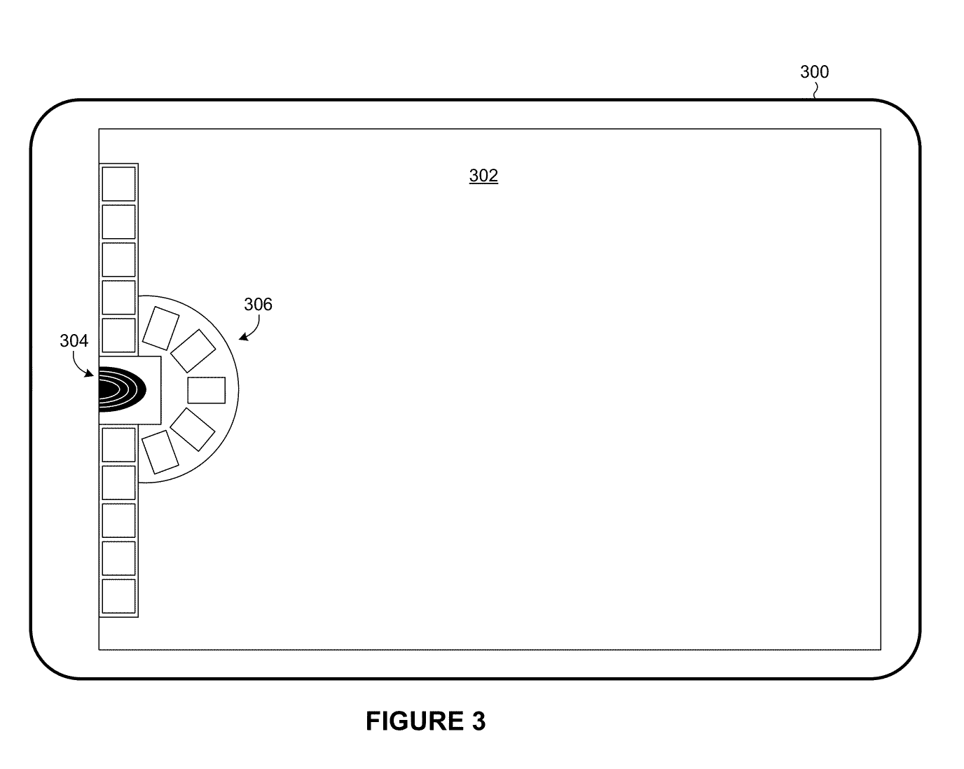

FIG. 3 illustrates a third example of an electronic device 300, such as the electronic devices 100 and 200 illustrated by FIGS. 1 and 2, respectively, in accordance with certain embodiments of the disclosed technology. In the example, the electronic device 300 has a display 302 configured to present to a user a GUI that includes a trigger mechanism component 304 and a rotational interface mechanism 306, which may be displayed responsive to a user performing a tap function, e.g., quick tap or double-tap, or otherwise placing his or her finger, e.g., thumb, on the trigger mechanism component 304.

In certain embodiments, the rotational interface mechanism 306 may continue to be displayed on the display 302 so long as the user's finger remains placed on the trigger mechanism component 304. The rotational interface mechanism 306 may be minimized—or no longer displayed at all—responsive to the user removing his or her finger from the trigger mechanism component 304. For example, the GUI may return to displaying the trigger mechanism component 304 but not the rotational interface mechanism 306.

In certain embodiments, a user may lock the rotational interface mechanism 306 in place by swiping his or her finger from a first pre-designated area, e.g., on or near the trigger mechanism component 304, to a second pre-designated area, e.g., any other portion of the display 302 outside of the rotational interface mechanism 306. While the user's finger may follow a particular path, e.g., an arc-type path, it should be noted that no single particular path is necessarily required. So long as the user swipes his or her finger from the first pre-designated area to the second pre-designated area in a single continuous motion, the “swipe-to-lock” functionality with regard to the rotational interface mechanism 306 may be performed.

In certain embodiments, responsive to a user locking the rotational interface mechanism 306, the GUI may continue to display the rotational interface mechanism 306 despite the user having removed his or her finger from the display 302 entirely, let alone the trigger mechanism component 304.

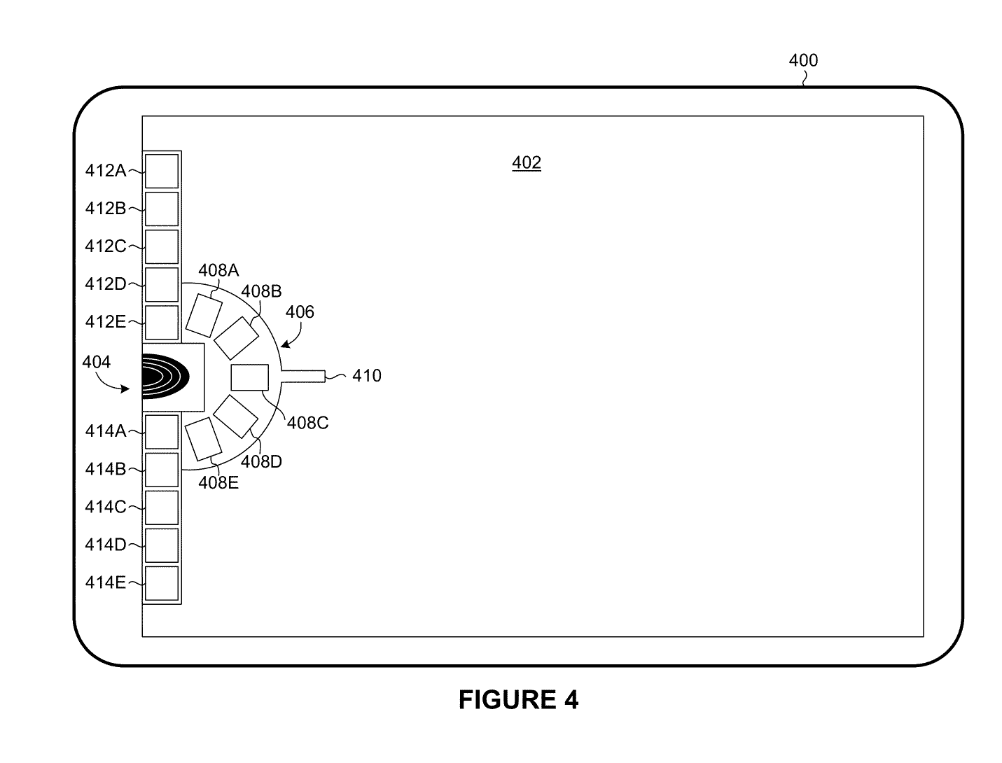

FIG. 4 illustrates a fourth example of an electronic device 400, such as the electronic devices 100-300 illustrated by FIGS. 1-3, respectively, in accordance with certain embodiments of the disclosed technology. In the example, the electronic device 400 has a display 402 configured to present to a user a GUI that includes a trigger mechanism component 404 and a rotational interface mechanism 406, which may be displayed responsive to a user placing his or her finger, e.g., thumb, on the trigger mechanism component 404.

In certain embodiments, the rotational interface mechanism 406 may be activated by virtue of the user touching, e.g., tapping or double-tapping, the rotational interface mechanism 406. In certain embodiments, this may include an enlargement of the rotational interface mechanism 406 as presented to the user via the display 402.

In the example, the rotational interface mechanism 406 has multiple toolset icons 408A-408E, one of which (408C) is in an active position, as indicated by a corresponding mode indicator 410. Because the toolset icon 408C is in the active position, corresponding individual tool icons 412A-412E may be displayed by GUI on the display 402 and thus made accessible to the user. Alternatively or in addition thereto, other individual tool icons 414A-414E may be displayed and made accessible to the user. Each of the individual tool icons 412A-412E and 414A-414E may correspond to any of a number of settings, functions, modes, etc. In certain embodiments, the individual tool icons 412A-412E and 414A-414E may be locked in place before the rotational interface mechanism 406 is displayed.

The rotational interface mechanism 406 may “spin” responsive to the user swiping his or her finger on the rotational interface mechanism 406 accordingly, for example. In certain embodiments, the rotational interface mechanism 406 functions as a virtual bicycle chain whose size, e.g., length, may be determined by the number of toolset icons within. The size of this virtual bicycle chain may be pre-established but dynamic. That is, the size, e.g., length, may change as toolset icons are added and/or removed therefrom. The rotational interface mechanism 306 may incorporate any of a number of notions of physics, e.g., inertia, movement velocity/acceleration, and spin parameters, as well as friction attributes. For example, if the rotational interface mechanism 406 is presently spinning, the user may cause the visual presenting thereof to slow down or stop by applying his or her finger thereto.

Once the user has selected a particular toolset or is otherwise finished with the rotational interface mechanism 406 for the time-being, he or she may cause the rotational interface mechanism 406 to minimize or otherwise no longer be displayed by tapping or double-tapping the rotational interface mechanism 406 or trigger mechanism component 404 or performing some other operation in connection therewith.

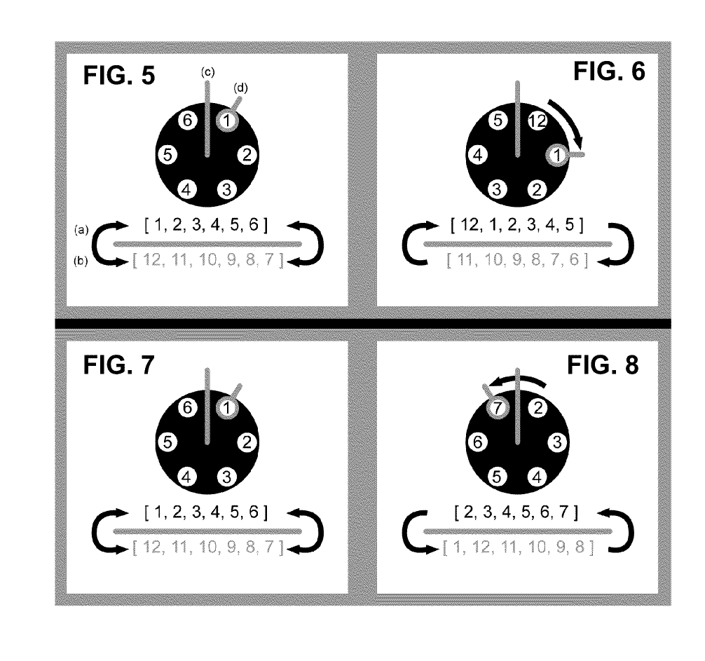

FIGS. 5-8 illustrate four distinct positions for a representation of a rotational interface mechanism implemented as a virtual bicycle chain. In these figures, six items are displayed at any given time. FIGS. 5 and 6 illustrate a first example in which items 1-6 are displayed and items 7-12 are not displayed (as illustrated by FIG. 5) until the virtual chain is “moved” by a user in a clockwise direction, after which items 1-5 and 12 are then displayed and items 6-11 are not displayed (as illustrated by FIG. 6). FIGS. 7 and 8 illustrate a second example in which items 1-6 are displayed and items 7-12 are not displayed (as illustrated by FIG. 7) until the virtual chain is “moved” by a user in a counterclockwise direction, after which items 2-7 are then displayed and items 1 and 8-12 are not displayed (as illustrated by FIG. 8).

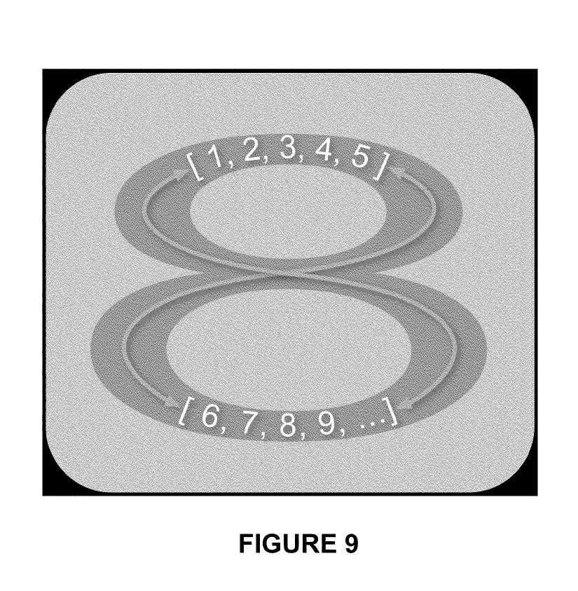

FIG. 9 illustrates an embodiment in which the rotational interface mechanism, e.g., 306 in FIG. 3, is implemented as a virtual loop, e.g., an infinite loop. The virtual loop implementation illustrated in FIG. 9 is similar to the virtual bicycle chain implementation illustrated in FIGS. 5-8 in that only a certain number of items are displayed at any given time. In the example, items 1-5 are presently displayed and items 6- . . . are not displayed. The number of items that are displayed, as well as the number of items that are not displayed, may be changed, e.g., as directed by a user. There is virtually no limit to either the number of items to be displayed or the number of items to not be displayed. The “size” of the virtual loop may be fixed or changeable. In an “infinite loop” implementation, for example, there is no limit to the number of items that may be added to the virtual loop.

It should be noted that interaction with certain aspects of the disclosed technology, such as the trigger mechanism component and rotational interface mechanism described above, may provide the user with an efficient, ergonomic, and overall enjoyable experience.

The following discussion is intended to provide a brief, general description of a suitable machine in which embodiments of the disclosed technology can be implemented. As used herein, the term “machine” is intended to broadly encompass a single machine or a system of communicatively coupled machines or devices operating together. Exemplary machines can include computing devices such as personal computers, workstations, servers, portable computers, handheld devices, tablet devices, communications devices such as cellular phones and smart phones, and the like. These machines may be implemented as part of a cloud computing arrangement.

Typically, a machine includes a system bus to which processors, memory (e.g., random access memory (RAM), read-only memory (ROM), and other state-preserving medium), storage devices, a video interface, and input/output interface ports can be attached. The machine can also include embedded controllers such as programmable or non-programmable logic devices or arrays, Application Specific Integrated Circuits, embedded computers, smart cards, and the like.

The machine can be controlled, at least in part, by input from conventional input devices, e.g., keyboards, touch screens, mice, and audio devices such as a microphone, as well as by directives received from another machine, interaction with a virtual reality (VR) environment, biometric feedback, or other input signal.

The machine can utilize one or more connections to one or more remote machines, such as through a network interface, modem, or other communicative coupling. Machines can be interconnected by way of a physical and/or logical network, such as an intranet, the Internet, local area networks, wide area networks, etc. One having ordinary skill in the art will appreciate that network communication can utilize various wired and/or wireless short range or long range carriers and protocols, including radio frequency (RF), satellite, microwave, Institute of Electrical and Electronics Engineers (IEEE) 545.11, Bluetooth, optical, infrared, cable, laser, etc.

Embodiments of the disclosed technology can be described by reference to or in conjunction with associated data including functions, procedures, data structures, application programs, instructions, etc. that, when accessed by a machine, can result in the machine performing tasks or defining abstract data types or low-level hardware contexts. Associated data can be stored in, for example, volatile and/or non-volatile memory (e.g., RAM and ROM) or in other storage devices and their associated storage media, which can include hard-drives, floppy-disks, optical storage, tapes, flash memory, memory sticks, digital video disks, biological storage, and other tangible, non-transitory physical storage media. Certain outputs may be in any of a number of different output types such as audio or text-to-speech, for example.

Associated data can be delivered over transmission environments, including the physical and/or logical network, in the form of packets, serial data, parallel data, propagated signals, etc., and can be used in a compressed or encrypted format. Associated data can be used in a distributed environment, and stored locally and/or remotely for machine access.

Having described and illustrated the principles of the invention with reference to illustrated embodiments, it will be recognized that the illustrated embodiments may be modified in arrangement and detail without departing from such principles, and may be combined in any desired manner. And although the foregoing discussion has focused on particular embodiments, other configurations are contemplated. In particular, even though expressions such as “according to an embodiment of the invention” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as may come within the scope and spirit of the following claims and equivalents thereto.

What is claimed is:

1. A machine-controlled method, comprising:
a display of an electronic device visually presenting to a user a graphical user interface (GUI) comprising a trigger mechanism component; and
responsive to an interaction between the user and the trigger mechanism component, the display visually presenting to the user a rotational interface mechanism comprising a plurality of toolset icons.

2. The machine-controlled method of claim 1, wherein the interaction between the user and the trigger mechanism component comprises the user tapping or double-tapping the trigger mechanism component.

3. The machine-controlled method of claim 1, wherein the interaction between the user and the trigger mechanism component comprises the user placing a finger on the trigger mechanism component.

4. The machine-controlled method of claim 3, wherein the display visually presents the rotational interface mechanism to the user so long as the user's finger remains placed on the trigger mechanism component.

5. The machine-controlled method of claim 1, further comprising the display locking the rotational interface mechanism responsive to an interaction between the user and the GUI.

6. The machine-controlled method of claim 5, wherein the interaction between the user and the GUI comprises the user swiping a finger from a first pre-designated area to a second pre-designated area.

7. The machine-controlled method of claim 6, wherein the first pre-designated area is on or near the trigger mechanism component.

8. The machine-controlled method of claim 7, wherein the second pre-designated area is any portion of the display outside of the rotational interface mechanism.

9. The machine-controlled method of claim 1, further comprising the display visually indicating to the user that a certain one of the plurality of toolset icons is currently active.

10. The machine-controlled method of claim 9, further comprising the display visually presenting to the user a plurality of individual tool icons that correspond to the certain one of the plurality of toolset icons.

11. The machine-controlled method of claim 1, further comprising the display causing the rotational interface mechanism to spin responsive to an interaction between the user and the rotational interface mechanism.

12. The machine-controlled method of claim 11, wherein the interaction between the user and the rotational interface mechanism comprises the user swiping a finger on the rotational interface mechanism in a clockwise or counterclockwise manner.

13. The machine-controlled method of claim 11, wherein the display applies at least one attribute in causing the rotational interface mechanism to spin.

14. The machine-controlled method of claim 13, wherein the at least one attribute is from a group consisting of inertia, movement velocity, movement acceleration, at least one spin parameter, and at least one friction attribute.

15. The machine-controlled method of claim 11, further comprising:
the display visually indicating to the user that a first one of the plurality of toolset icons is active before causing the rotational interface mechanism to spin; and
the display visually indicating to the user that a second one of the plurality of toolset icons is active after causing the rotational interface mechanism to spin.

16. The machine-controlled method of claim 15, further comprising:
the display visually presenting to the user a first plurality of individual tool icons that correspond to the first one of the plurality of toolset icons before causing the rotational interface mechanism to spin; and
the display visually presenting to the user a second plurality of individual tool icons that correspond to the second one of the plurality of toolset icons after causing the rotational interface mechanism to spin.

17. The machine-controlled method of claim 1, wherein the electronic device is a handheld computing device.

18. One or more non-transitory machine-readable storage media configured to store machine-executable instructions that, when executed by a processor, cause the processor to perform the machine-controlled method of claim 1.

19. A handheld electronic device, comprising:
a display configured to visually present to a user a graphical user interface (GUI) comprising a trigger mechanism component; and
a processor configured to cause the display to visually present to the user a rotational interface mechanism responsive to an interaction between the user and the trigger mechanism component, the rotational interface mechanism comprising a plurality of toolset icons.

20. The handheld electronic device of claim 19, wherein the processor is further configured to cause the display to visually present to the user a plurality of individual tool icons that correspond to a certain one of the plurality of toolset icons.
